(19) United States
(12) Patent Application Publication
(10) Pub. No.: US 2005/0094272 A1
(43) Pub. Date: May 5, 2005

(54) Wavelength characteristic variable filter, optical amplifier, and optical communications apparatus

(75) Inventors: Norihisa Naganuma, Yokohama (JP); Nobuaki Mitamura, Yokohama (JP); Shinji Maruyama, Yokohama (JP); Hiroshi Nagaeda, Yokohama (JP); Hirotomo Izumi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/821,857

(22) Filed: Apr. 12, 2004

(30) Foreign Application Priority Data
Nov. 4, 2003 (JP) 2003-374318

(51) Int. Cl. G02B 5/18

(52) U.S. Cl. 359/579; 359/566

(57) ABSTRACT

Light emitted from an optical fiber is collimated by a collimating lens. An optical filter with a slit is placed in the path of the collimated light. The slit can be moved along a direction perpendicular to the path of the collimated light. When the slit is on the center of the collimated beam, because the intensity of light is high at the center, the diffraction loss of the light is high. When the slit is on the edge, because the light intensity is low at the edge, the diffraction loss is low. The diffraction loss has a wavelength characteristic and can be controlled by adjusting the position of the slit in the collimated beam.

### CROSS-REFERENCE TO RELATED APPLICATIONS

This application is based upon and claims the benefit of priority from the prior Japanese Patent Application No. 2003-374318, filed on Nov. 4, 2003, the entire contents of which are incorporated herein by reference.

### BACKGROUND OF THE INVENTION

1) Field of the Invention

The present invention relates to a wavelength characteristic variable filter that is provided in optical amplifiers, transmission paths and the like in the wavelength multiplex optical communication systems and that can variably set the wavelength characteristic.

2) Description of the Related Art

In high-density wavelength multiplex optical communication systems adopting a wavelength division multiplex (WDM) mode, an optical signal is multiplexed for a plurality of channels (ch) over a band from tens of nanometers (nm) to hundred nm, so that there is a demand to flatten the optical output levels of all the channels. Therefore, an optical fiber amplifier (EDFA) having large gain wavelength characteristic is provided with a gain equalizer (GEQ) (for example, see Japanese Patent Application Laid-Open Publication Nos. 2002-299733 and 2002-268028). Since the gain wavelength characteristic of the gain equalizers changes due to a change in the gain, the gain equalizers are required to be designed and manufactured for respective gains. Further, flatness of the optical output of the channels depends on a lot of causes such as the Raman amplifier gain wavelength characteristic, the loss wavelength characteristic of the fiber, and the optical output deviation of each channel. Consequently, there is a need for filters that can change the wavelength characteristics easily.

Various types of wavelength characteristic variable filters are known. Some filters spatially divide the wavelength using a diffraction grating and change an optical path for each wavelength using liquid crystal, MEMS or the like so as to introduce a loss. Other filters change the wavelength characteristics by means of a magneto-optical element (for example, see Japanese Patent Application Laid-Open Publication No. H9-258117).

However, the diffraction gratings or the magneto-optical elements are expensive, and the diffraction gratings are also bulky.

### SUMMARY OF THE INVENTION

It is an object of the present invention to solve at least the problems in the conventional technology.

A wavelength characteristic variable filter according to an aspect of the present invention includes a filter that is arranged in a path of a collimated beam and having a diffraction unit that is movable in a direction perpendicular to a direction of the collimated beam, wherein a wavelength characteristic of the filer is such that a transmittance changes with wavelength; and a moving unit that moves the diffraction unit.

An optical amplifier according to another aspect of the present invention includes a filter that is arranged in a path of a collimated beam and having an edge that is movable in a direction perpendicular to a direction of the collimated beam, wherein a wavelength characteristic of the filer is such that a transmittance with respect to a wavelength is set; and a moving unit that moves the edge of the filter to a predetermined position between a center and an edge of the collimated beam.

An optical communications apparatus according to still another aspect of the present invention includes a filter that is arranged in a path of a collimated beam and having an edge that is movable in a direction perpendicular to a direction of the collimated beam, wherein a wavelength characteristic of the filer is such that a transmittance with respect to a wavelength is set; and a moving unit that moves the edge of the filter to a predetermined position between a center and an edge of the collimated beam.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram to explain the principle of generation of diffraction light;

FIG. 2A is a diagram to explain positions to which a diffraction unit is moved within a beam;

FIG. 2B is a graph of wavelength characteristics when the diffraction unit is at the positions shown in FIG. 2A;

FIG. 3 is a plan view of a wavelength characteristic variable filter according to a first embodiment of the present invention;

FIG. 4 is a perspective view of a filter with a slit;

FIG. 5 is a plan view of a wavelength characteristic variable filter according to a second embodiment of the present invention;

FIGS. 6A to 6C are side views of a wavelength characteristic variable filter according to a third embodiment of the present invention;

FIGS. 7A to 7C are graphs of the wavelength characteristic of the wavelength characteristic variable filter; and

FIG. 8 is a perspective view of an etalon plate as the wavelength characteristic variable filter.

### DETAILED DESCRIPTION

Exemplary embodiments of a wavelength characteristic variable filter, an optical amplifier, and an optical communications apparatus according to the present invention are explained below in detail with reference to the accompanying drawings.

First, an explanation will be given in simple words about the principle by which the wavelength characteristic variable filter of the present invention makes it possible to make the wavelength characteristic variable. In general, when there is a diffraction unit such as an edge, a slit, or a hole which blocks light in the path of a collimated beam, the light is diffracted and a component (diffracted light) that advances in direction that is different from that of the collimated light is produced. Such diffraction results into an increase in an insertion loss at the time of fiber coupling for unshielded light. When an optical filter is used as a shielding portion here, it is seen as the diffraction unit for a wavelength with low transmittance, and the diffraction occurs. The optical fiber is, however, seen as transparent for a wavelength with high transmittance, and thus the diffraction hardly occurs in a portion where the diffraction unit is present.

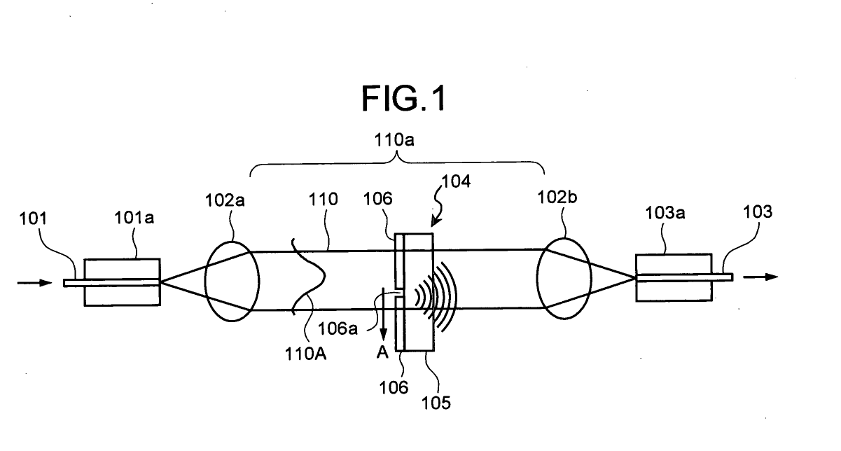

FIG. 1 is a diagram to explain the principle of generation of the diffraction light. Light 110 emitted from an end surface of a fiber ferrule 101a at the end of one optical fiber 101 is converted into a parallel collimated beam 110a between a pair of collimating lenses 102a and 102b. The parallel collimated beam 110a enters an end surface of a fiber ferrule 103a of other optical fiber 103. For the sake of convenience, the light, which is collimated, in region between the collimating lenses 102a and 102b is termed as collimated beam 110a and the light intensity of the collimated beam 110a along an axis that is perpendicular to the optic axis of the collimated beam 110a is designated by 110A. The light intensity 110A is highest at the center of the collimated beam 110a.

An optical filter 104 is provided in of the path of the collimated beam 110a. The optical filter 104 is formed, for example, in the following manner. That is, a filter film 106 having a predetermined wavelength transmission property is formed on a surface of a glass board 105, and a slit 106a is formed in a part of the filter film 106. The slit 106a is composed of, for example, a pair of edges. When the optical filter 104 is located in such a manner that the slit 106a is on the center, i.e., on the optic axis, of the collimated beam 110a, diffraction of the collimated beam 110a takes place and there occurs a diffraction loss. Because the slit 106a is on the center of the collimated beam 110a, where there is the highest light intensity, the diffraction loss is the highest.

Diffraction takes place and there occurs a diffraction loss even when the slit 106a is located at the edge of the collimated beam 110a by moving the optical filter 104 along a direction shown by an arrow A. However, because the light intensity is low at the edge than at the center of the collimated beam 110a, the diffraction is less. That is to say, the diffraction loss has a wavelength characteristic. The slit 106a is about 1/10 of a beam diameter of the collimated beam 110a. For example, when the beam diameter of the collimated beam 110a is 200 micrometer (μm), a width of the slit 106a is set to be 40 μm or less. The slit 106a can be formed by a pair of dielectric multilayer films (detailed later) or the like having the same wavelength characteristic.

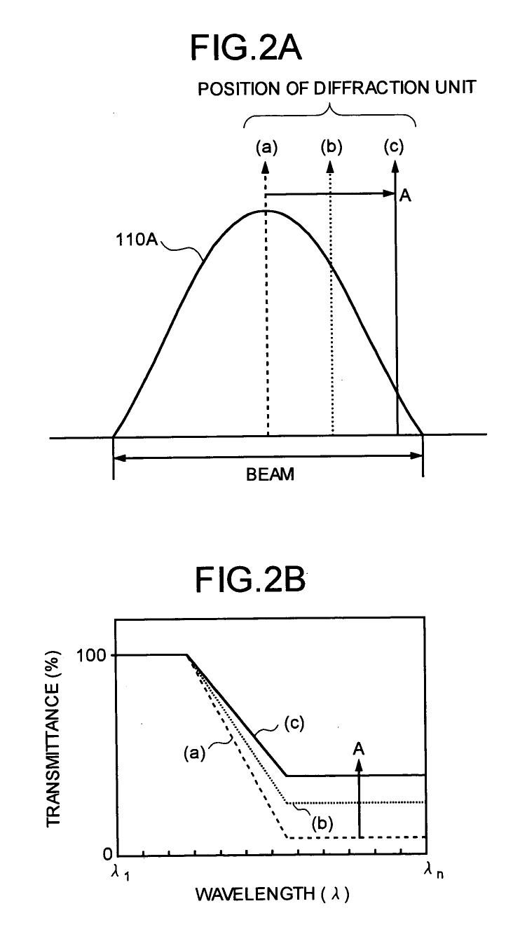

FIG. 2A is a diagram to explain positions to which the diffraction unit is moved within the beam, and FIG. 2B is a graph of the wavelength characteristic when the diffraction unit is at the positions shown in FIG. 2A. The wavelength is plotted along the horizontal axis, and the transmittance is plotted along the vertical axis in FIG. 2B. When the slit 106a, which is the diffraction unit, is moved from the center of the collimated beam 110a where the optical power of the collimated beam 110a is strong to the edge of the collimated beam 110a where the optical power is weak in the order of (a), (b), and (c) as shown in FIG. 2A, the diffraction loss drops in a part of the wavelength band, and accordingly the transmittance increases as shown by (a), (b), and (c) in FIG. 2B.

In this manner, the wavelength characteristic can be added to the filter characteristic just by moving the slit 106a within the collimated beam 110a, so that a filter which can change the wavelength characteristic can be realized. Particularly when the slit 106a is moved, the transmittance does not change in the wavelength band with high transmittance, but the transmittance and the wavelength characteristic can be changed more easily in the wavelength band with lower transmittance. That is to say, by inserting a filter having such a diffraction unit into the light beam having intensity distribution and by adjusting a position of the diffraction unit, it is possible to change the characteristic of the filter.

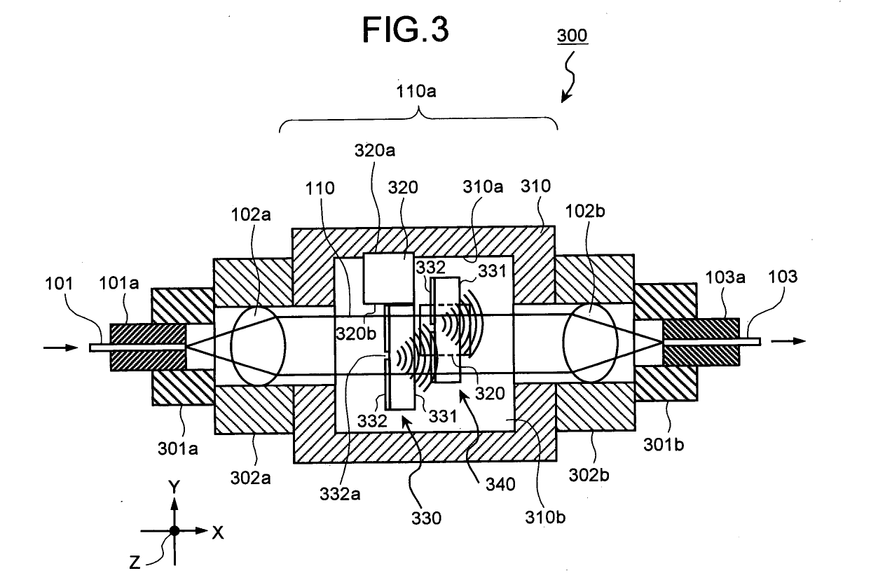

FIG. 3 is a plan view of a wavelength characteristic variable filter according to a first embodiment of the present invention. In a wavelength characteristic variable filter 300, the components that have the same or similar configuration or that perform same or similar functions to those shown in FIG. 1 are designated by the same reference numbers. A pair of optical fibers 101 and 103 are arranged, at locations that are separated by a predetermined distance, in such a manner that their optical axes are coaxial. The fiber ferrule 101 a of the optical fiber 101 is fixed to a sleeve 301 a and the fiber ferrule 103a of the optical fiber 103 is fixed to a sleeve 301b. The collimating lens 102a is fixed to a sleeve 302a and the collimating lens 102b is fixed to a sleeve 302b. The sleeve 301 a is fixed to the sleeve 302a, and the sleeve 302a is fixed to a casing 310. Similarly, the sleeve 301b is fixed to the sleeve 302b, and the sleeve 302b is fixed to the casing 310. The sleeves 301a, 301b, 302a, and 302b and the casing 310 are constituted by shaping a metal material, and they are fixed to each other by laser welding. At the time of the fixing, axes in three directions (X axis, Y axis and Z axis) are adjusted so that the light 110 emitted from the optical fiber 101 becomes the collimated beam 110a.

A base end portion 320a of a position displacement unit 320 for making displacement to a direction (Y axial direction) perpendicular to the optical axis (X axial direction in the drawing) of the collimated beam 110a is fixed to a side wall surface 310a of the casing 310. The position displacement unit 320 can be composed of piezoelectric elements piezoelectrically driven, for example. A voltage is applied to an electrode, not shown, from an external power supply, so that the position of a moving end 320b can be moved continuously to a desired position in the direction perpendicular to the optical axis of the collimated beam 110a. Filters 330 and 340s are fixed to the moving end 320b so that the moving end 320 is located on the optical axis of the collimated beam 110a.

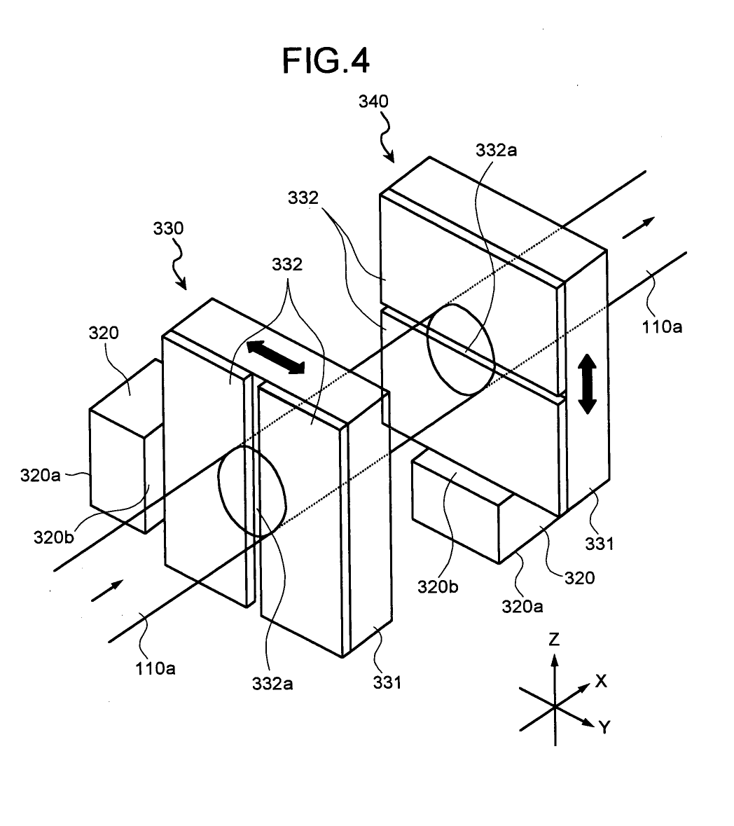

FIG. 4 is a perspective view of the filters 330 and 340 with the slits. The filters 330 and 340 have a two-stage constitution including a fore-stage and a post-stage. The filter 330 at the fore-stage is constituted by etching or dicing a dielectric multilayer film 332 composing the optical filter on a glass board 331. A slit 332a which extends in a vertical (Z-axial) direction in the drawing is formed on a center position of the dielectric multilayer film 332. The slit 332a is formed by a pair of edges. The explanation refers to that the filter 330 with slit is perpendicular (vertical) to the optical axis of the collimated beam 110a, but actually the filter 330 is tilted through a several angle with respect to the optical axis so as to release reflection.

The filter 340 at the post-stage has the same constitution as that of the filter 330 at the fore-stage, and the respective portions are designated by the same reference numbers. The base end portion 320a of the position displacement unit 320 is joined to an inner bottom surface 310b (see FIG. 3) of the casing 310, and the glass board 331 is fixed to the moving end 320b at the upper portion. The slit 332a which extends in a horizontal (Y-axial) direction in the drawing is formed on the center position of the dielectric multilayer film 332.

The light 110 can be diffracted by the slit 332a of at least one filter (for example, only the filter 330 with slit at the fore-stage). When the two filters 330 and 340 are used, a diffraction loss that is larger than when only one filter is used can be obtained. A diffraction angle formed by one filter with is obtained by wavelength/slit width (radian), and for example, when the wavelength is 1.5 microns and the slit width is ten microns to several microns, the diffraction angle of several degrees can be obtained.

The filters 330 and 340 are fixed to the different position displacement units 320, respectively, so that their position displacement directions are perpendicular to each other. When the movable directions are set to be perpendicular to each other and when the slits 332a of the filters 330 and 340 are located on the center of the collimated beam 110a, the diffraction directions become perpendicular to each other so that a larger diffraction loss can be obtained. To simplify the manufacturing, two or more filters with slits may be arranged on the single position displacement unit, so that the filters with slit can be displaced to the same direction.

It has been explained above that the position displacement directions of the filters 330 and 340 are perpendicular to each other; however, same results can be obtained if the directions of the slits 332a of the filters 330 and 340, or the directions of the position displacement make a predetermined angle with each other.

The position displacement unit 320 can be realized by not only the piezoelectric driving method using the piezoelectric elements but also an electrostatic force method using a diaphragm having a comb-shaped electrode, a thermal expansion method using bimetal, a magnetic force method using an electromagnet, pulse motor or the like, and the like. With these methods, the filters can be displaced similarly. Further, the above constitution is such that the slit 332a is formed on the dielectric multilayer film 332 on the glass board 331 by a pair of edges, but the constitution is not limited to the forming of the slit. For example, instead of the slit, an edge of a partial filter can diffract the light. That is to say, the partial filter whose one edge is positioned on the portion of the light 110 (collimated beam 110a) can be formed similarly by etching or a lift-off method.

How the filtering is performed will now be explained. The light 110 emitted from the end surface of the optical fiber 101 on the input side is converted into collimated beams (parallel light) by the collimating lens 102a, so as to pass through the filters 330 and 340. One or both of the position displacement units 320, which is (are) provided on the filters 330 and 340 on the fore-stage and the post-stage, respectively, is (are) driven. At this time, one or both of the slits 332a of the filters 330 and 340 is (are) moved to a desired position between the center position of the collimated beam 110a and the position out of the beam.

As a result, as shown in FIG. 2, the transmittance of a partial wavelength band can be changed so as to be desired transmittance according to the displaced position. The filters 330 and 340 change the transmittance of the light which passes through the filters 330 and 340 in the partial wavelength band. The light is converged on the end surface of the optical fiber 103 by the collimating lens 102b and the light enters into the optical fiber 103.

According to the first embodiment, since transmittance in a certain wavelength band of a wavelength multiplexed light can be changed, the wavelength characteristic of the respective channels in the entire communication wavelength such as OSNR (Optical Signal Noise Ratio) can be flattened. Since the wavelength characteristic can be changed only by displacing the position of the filters with slits, the flattening of the output levels of all the channels can be achieved with simple and small-scale constitution and at low costs.

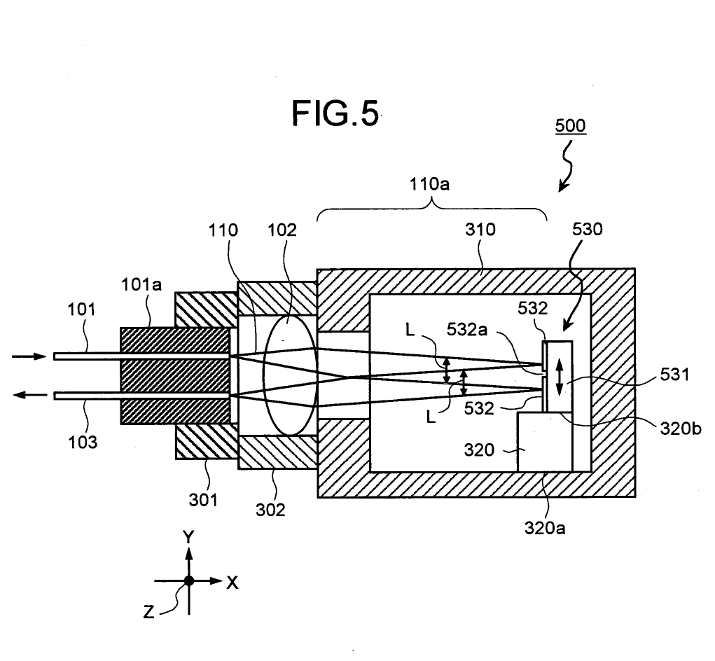

FIG. 5 is a plan view of a wavelength characteristic variable filter according to a second embodiment of the present invention. In a wavelength characteristic variable filter 500 shown in FIG. 5, the same components as those in the first embodiment (see FIG. 3) are designated by the same reference numbers. The second embodiment has the constitution that the light on the incident side is reflected and the light on the emission side is led to the same direction as that on the incident side.

The optical fiber 101 for input and the optical fiber 103 for output are fixed to the single fiber ferrule (double core ferrule) 101a. Moreover, the light emitted from the optical fiber 101 is converted into the collimated beam 110a by the one collimating lens 102. The width of the beam 110a is designated by L in the drawing. The collimated beam 110a reflected by the filter 530 with slit is converged on and enter the optical fiber 103 by the collimating lens 102. A filter 530 with slit according to the second embodiment is different from the first embodiment not in the wavelength characteristic of the transmittance but the wavelength characteristic of the reflection. Reference numeral 532 designates the dielectric multilayer film.

The base end portion 320a of the position displacement unit 320 composed of piezoelectric elements or the like is fixed to the casing 310, and the filter 530 with slit is fixed to the moving end 320b. The position of the slit 532a can be displaced with respect to the collimated beam 110a by driving the position displacement unit 320, so that the wavelength characteristic is variable. The wavelength characteristic of the filter 530 with slit is a reflected (reversed) wavelength characteristic. For example, when the filter 530 with slit is formed by the wavelength characteristic of a band-pass filter (BPF), the collimated beam 110a to be reflected has a wavelength characteristic of a band rejection filter (BRF). Further, when the filter 530 is formed by a wavelength characteristic of a low-pass filter (LPF), the collimated beam 110a to be reflected has a wavelength characteristic of a high-pass filter (HPF).

According to the second embodiment, since transmittance in a certain wavelength band of a wavelength multiplexed light can be changed, the wavelength characteristic of the respective channels in the entire communication wavelength can be made constant (flattened). Since the wavelength characteristic can be changed only by displacing the position of the filters with slit, the flattening of the output levels of all the channels can be achieved with simple and small-scale constitution and at low costs. Particularly, in comparison with the first embodiment, only one collimating lens is used, and a length of the light in the optically axial direction (direction X in the drawing) can be shortened by the reflection folded optical path, so that the filters can be further miniaturized. Further, the optical fibers for input/output are arranged so as to be parallel with each other and face one direction, and a mounting space can be saved, so that workability of connector connection and the like can be improved.

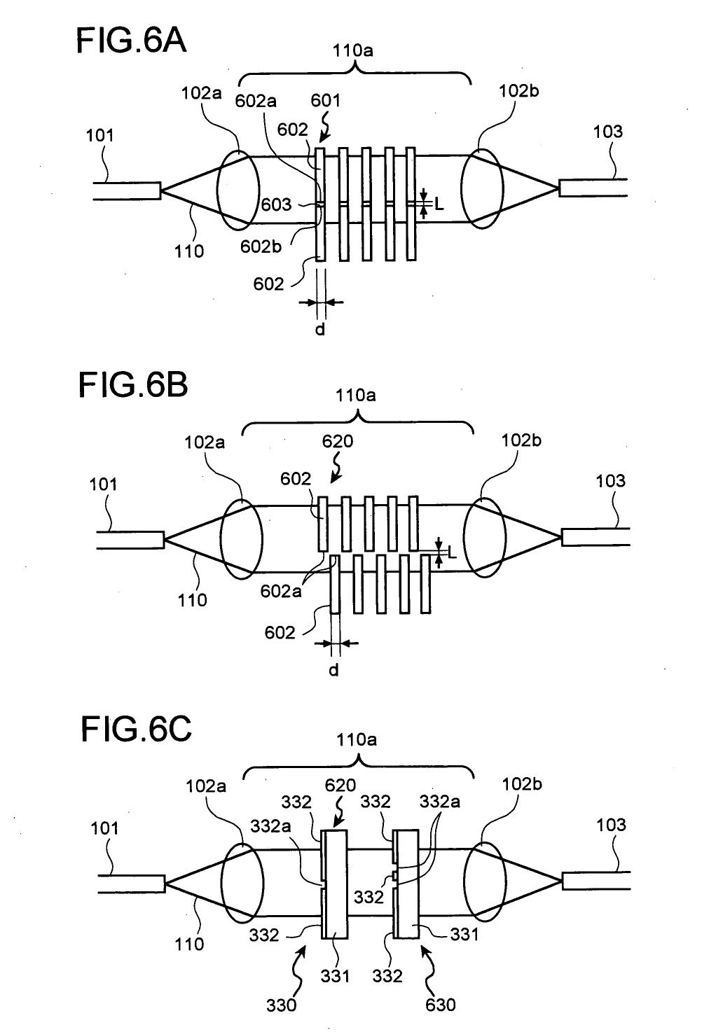

Various constitution of the filters used as the wavelength characteristic variable filter of the present invention are explained below. As explained above, the filters can be constituted so that the slit or the edge is provided on the optical path of the light (collimated beam). FIGS. 6A, 6B, and 6C are side views of a wavelength characteristic variable filter according to a third embodiment of the present invention.

The wavelength characteristic variable filter 601 shown in FIG. 6A is constituted so that a pair of filters 602 having very small thickness, of the order of several tens of microns, are bonded and fixed to each other in an up-down manner by adhesive 603. The portions where the paired filters 602 are bonded by the adhesive 603 become transparent slits, and one slit has a pair of edges 602a and 602b. An edge width L of the slit is illustrated in the drawing. As such a thin filter, a filter which is constituted so that the dielectric multilayer film is deposited on a polyimide film board, generally has a width d of 27 μm to 30 μm. A filter which is constituted only by the dielectric multilayer film without a board generally has a thickness d of about 30 μm.

Since the one wavelength characteristic variable filter 601 can be formed so as to have a small thickness, a length area of the collimated beam 110a can be a short optical path. As a result, a lot of the wavelength characteristic variable filter 601 can be inserted into the short optical path. In an example shown in FIG. 6A, the five wavelength characteristic variable filters 601 having the similar constitution are provided. When the plural wavelength characteristic variable filters 601 are arranged, the respective wavelength characteristic variable filters 601 may have different wavelength characteristics. In this case, the wavelength characteristics can be changed arbitrarily by synthesizing the wavelength characteristics. In the drawing, the wavelength characteristic variable filters 601 are arranged so as to be perpendicular to the optical axis of the collimated beam 110a, but actually they are tilted slightly so that an influence of light reflection is reduced. Further, when the wavelength characteristic variable filters 601 are tilted, so that a wavelength shift can be adjusted.

It is considered that when all the plural wavelength characteristic variable filters 601 having the above constitution have the same wavelength characteristics, they are fixed to one position displacement unit 320 (see FIG. 3) so as to be displaced similarly. It is considered that when the plural wavelength characteristic variable filters 601 having different wavelength characteristics are used, they are fixed to the individual position displacement units 320, respectively, so as to be displaced individually. The constitution is not limited to these examples. It is, therefore, considered that all the plural wavelength characteristic variable filters 601 having the same wavelength characteristic are displaced individually or the wavelength characteristic variable filters 601 having different wavelength characteristics are displaced together.

A wavelength characteristic variable filter 620 shown in FIG. 6B has the edge width L similar to that of the filter 602 shown in FIG. 6A, and the filters 620 are arranged so as to be shifted to the optically axial direction of the collimated beam 110a alternately. In the example of FIG. 6B, since one edge 602a is formed by one filter 602, the number of edges can be doubled in comparison with the constitution in FIG. 6A. With this constitution, while the number of the edges for diffracting the light are increased within a short distance, the diffraction loss can be increased. In the constitution shown in FIG. 6B, the wavelength characteristic variable filters 620 are fixed to the single or individual position displacement unit(s) 320 (see FIG. 3), so as to be displaced.

In a constitution shown in FIG. 6C, the filter 330 (see FIG. 3) having one slit 332a is arranged on the fore-stage, and the filter 630 having the plural slits 332a (in the drawing, two) is arranged on the post-stage. In the filter 630 with filter at the post-stage, similarly to the filter 330 with the slit at the fore-stage, the portion of the dielectric multilayer film 332 can be etched or diced so that the two slits 332a can be formed. It is necessary to set a pitch between the slits 332a sufficiently small with respect to the beam diameter of the collimated beam 110a. For example, the pitch between the two slits 332a is 1/4 or less of the collimated beam. When the plural slits 332a are provided, all the slits should be provided with this pitch. With this constitution, the slits 332a can be inserted into and arranged on different positions of the intensity distribution on the collimated beam 110a. As a result, the diffraction loss can be increased.

In the third embodiment, the linear slits and edges are provided, but they are not limited to the linear shape, and they can have various shapes including a circular shape, an oval shape and the like.

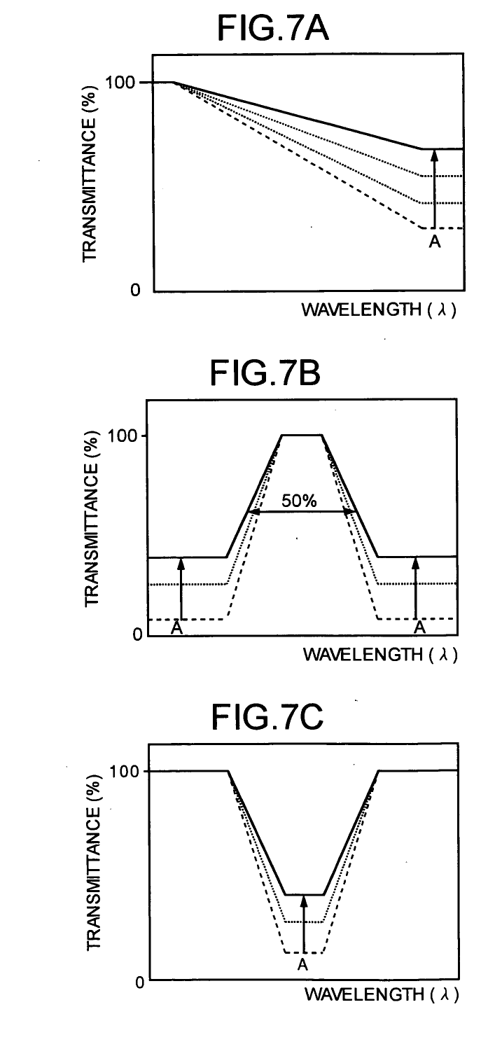

The wavelength characteristic filters explained in the above embodiments can have various wavelength characteristics. A fourth embodiment explains these various wavelength characteristics. FIGS. 7A, 7B, and 7C are graphs of wavelength characteristics of various wavelength characteristic variable filters.

FIG. 7A is a graph of the wavelength characteristic when a loss tilt is variable. This exemplifies a short-wave pass filter (SWPF). The short-wave pass filter can be used in order to correct a change in the wavelength characteristic (loss in a partial wavelength) with respect to a distance of the optical fiber laid in a log distance and flatten the wavelength characteristic in the entire communication wavelength band. The wavelength on the horizontal axis in the drawing corresponds to a wavelength band for multi-channels (for example, 1530 nm to 1560 nm).

FIG. 7B is a chart of the wavelength characteristic when a half-width is variable. This exemplifies a band-pass filter (BPF). The half-width (band) defined in the optical communication measurement or the like is changed so that a frequency spectrum (resolution) in a specified one channel can be changed. The wavelength on the horizontal axis in the drawing corresponds to a narrower band (for example, 1550 nm to 1550.4 nm).

FIG. 7C is a graph of the wavelength characteristic when a transmittance of a specified wavelength is variable. This exemplifies a band-rejection filter (BRF). This filter can be used for correcting gain of the above-mentioned gain equalizer (GEQ). The horizontal axis in the drawing corresponds to a wavelength band for multi-channels (for example, 1530 nm to 1560 nm).

In these wavelength characteristic variable filters, the position of the slits (or edges) is changed with respect to the collimated beam 110a by using the position displacement unit 320, so that the transmittance in a wavelength band with particularly low transmittance can be changed. As shown in FIG. 1, when the position of the slits (or edges) is moved from the center of the collimated beam 110a to the edge, the transmittance can be increased.

The dielectric multilayer film 332 is constituted generally by forming silicon oxide (SiO2) and titanium oxide (TiO2) are formed into a layer shape (several layers to several hundred layers) alternately. The number of the layers and thickness of the layers is, however, changed, so that the aforementioned respective wavelength characteristics can be obtained. Also the wavelength characteristic in which the wavelength characteristics shown in FIGS. 7A to 7C are compounded can be obtained.

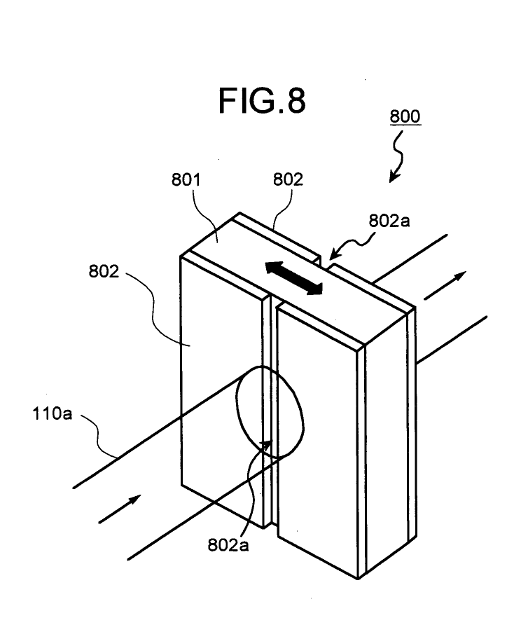

In the embodiments, the filters use the dielectric multilayer films, but the constitution is not limited to this, and the wavelength characteristic variable filter can be composed of the etalon board. FIG. 8 is a perspective view of an etalon board as the wavelength characteristic variable filter. A HR (high reflection) mirror as a light reflection film 802 is formed on both surfaces of the glass board 801 composing the etalon board 800. Only the light with wavelength of 2π (collimated beam 110a) is allowed to transmit according to the thickness of the glass board 801, and light with the other wavelengths is attenuated by internal multiple reflection. A slit 802a in the drawing is formed on a part of the light reflection film 802 of the etalon board 800. As a result, a transmission-type band-pass filter can be constituted, and when the etalon board 800 is moved (to the direction of arrow) on the optical axis of the collimated beam 110a similarly to the embodiments, the transmittance of the light is variable.

As explained above, according to the wavelength characteristic variable filter, the edge of the filter is moved with respect to the collimated beam, so that the transmittance in a predetermined wavelength band can be changed. For this reason, when the filter is arranged on the optical path of a wavelength multiplex apparatus or is incorporated into EDFA or a Raman amplifier so as to be used for correcting a spectrum tilt, a power deviation which is different from a design value between the channels on the actual fiber transmission path can be adjusted.

According to the wavelength characteristic variable filter of the present invention, the wavelength characteristic can be changed by displacing with respect to an optical axis a diffraction unit of the filter. Therefore, a simple and. small wavelength characteristic variable filter can be obtained at low cost.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A wavelength characteristic variable filter comprising:
a filter that is arranged in a path of a collimated beam and having a diffraction unit that is movable in a direction perpendicular to a direction of the collimated beam, wherein a wavelength characteristic of the filer is such that a transmittance changes with wavelength; and
a moving unit that moves the diffraction unit.

2. The wavelength characteristic variable filter according to claim 1, wherein the diffraction unit is a slit having a pair of edges, wherein the slit is formed by removing a part of a film from a surface of the filter.

3. The wavelength characteristic variable filter according to claim 2, wherein
a plurality of the filters are arranged in the path of the collimated beam, and
the moving unit moves all or some of the slits simultaneously.

4. The wavelength characteristic variable filter according to claim 3, wherein the slits of adjoining filters make a predetermined angle with each other.

5. The wavelength characteristic variable filter according to claim 3, wherein the moving unit moves all the slits in one direction or moves each slit in a respective direction.

6. The wavelength characteristic variable filter according to claim 1, wherein the filter has a plurality of the diffraction units, the diffraction units are edges, and the edges are formed at a pitch of 1/4 or less of a beam diameter of the collimated beam.

7. The wavelength characteristic variable filter according to claim 1, wherein the moving unit moves the diffraction unit by using any one of an electromagnetic force driving mechanism, a thermal expansion driving mechanism, a piezoelectric effect driving mechanism, and an electrostatic force driving mechanism, or a combination thereof.

8. The wavelength characteristic variable filter according to claim 3, wherein the filters have different wavelength characteristics.

9. The wavelength characteristic variable filter according to claim 1, wherein a reflection type filter is used as the filter, and
a direction from which light enters in the reflection type filter and a direction towards which light is emitted out from the reflection type filter are same.

10. The wavelength characteristic variable filter according to claim 2, wherein the filter is an etalon filter in which the edges are formed on one portion of a reflection film.

11. An optical amplifier comprising:
a filter that is arranged in a path of a collimated beam and having an edge that is movable in a direction perpendicular to a direction of the collimated beam, wherein a wavelength characteristic of the filer is such that a transmittance with respect to a wavelength is set; and
a moving unit that moves the edge of the filter to a predetermined position between a center and an edge of the collimated beam.

12. An optical communications apparatus comprising:
a filter that is arranged in a path of a collimated beam and having an edge that is movable in a direction perpendicular to a direction of the collimated beam, wherein a wavelength characteristic of the filer is such that a transmittance with respect to a wavelength is set; and
a moving unit that moves the edge of the filter to a predetermined position between a center and an edge of the collimated beam.
